(19) United States
(12) Patent Application Publication
(10) Pub. No.: US 2006/0150211 A1
(43) Pub. Date: Jul. 6, 2006

(54) Method and terminal for limited-access receiving of data as well as remote server

(75) Inventor: Rudolf Ritter, Zollikofen (CH)

Correspondence Address: PEARNE & GORDON LLP, 1801 EAST 9TH STREET, SUITE 1200, CLEVELAND, OH, 44114-3108, US

(73) Assignee: Swisscom Mobile AG, Bern (CH)

(21) Appl. No.: 11/321,279

(22) Filed: Dec. 29, 2005

(30) Foreign Application Priority Data
Dec. 31, 2004 (EP) 2004EP-1070780

(51) Int. Cl. H04N 7/167

(52) U.S. Cl. 725/31; 380/200

(57) ABSTRACT

A method for limited-access receiving of data is disclosed. In a remote server (5), data for decoding user data are encrypted with the first key, which has been generated on the basis of the user's biometric or key data derived therefrom, and sent as program-accompanying data through a broadcast system. In a terminal (1) of the user, the information received through the broadcast system are decrypted with the second key, that has also been generated on the basis of the user's biometric or key data derived therefrom. The user data are decoded with the received decrypted data for decoding user data and the received user data can be reproduced. The present invention also relates to the remote server (5) and the terminal (1).

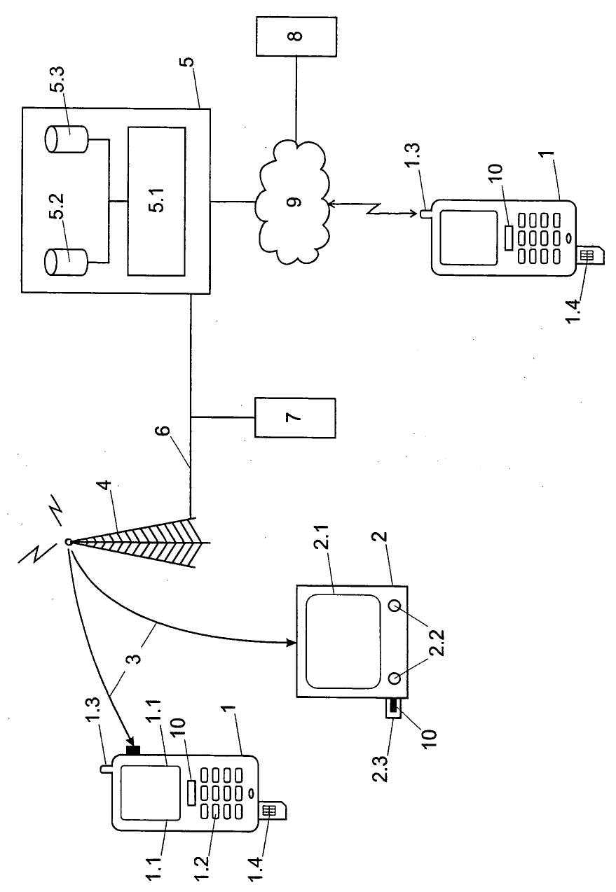

### REFERENCE DATA

This application claims priority from European patent application EP04107078.0 filed on Dec. 31, 2004, the contents of which are hereby incorporated by reference.

### TECHNICAL FIELD

The present invention concerns a method for limited-access receiving of audio and/or video data according to the independent method claim, a remote server according to the independent claim 18 and a terminal according to the independent claim 21.

### TECHNICAL BACKGROUND

Such methods are already used in many ways, e.g. for accessing Internet sites or receiving television programs broadcast in so-called Pay-TV. In Pay-TV, receiving broadcast current news reports such as e.g. a direct transmission of sports events is however subject to payment of access fees. To receive these broadcasts, in contrast to programs broadcast by public law program providers, a condition is to have additional devices and to evidence entitlement or access authorization. The receiving of digitally broadcast programs in Pay-TV is thus only possible with a decoder that, to receive it, has to convert a program broadcast encoded and with an entitlement, e.g. in the form of a chip card. The decoder is either directly supplied by the program provider or, if bought otherwise in a specialized shop, must work according to the coding type used by the program provider.

The chip card usually made available directly by the program provider contains user-specific secret keys that serve for decrypting security-related messages, so-called entitlement management messages (EMM). The EMMs determine which user has commercially acquired an entitlement for which programs. The EMMs contain in addition to entitlements further information such as for example also a cryptographic key with which messages for checking the entitlement (entitlement control messages, hereinafter also ECM) can be decrypted.

The ECMs contain predetermined entitlements and the session key with which broadcasts or programs transmitted encrypted can be decoded. The ECMs are sent to the recipients once or continuously at short time intervals during the broadcast of a program. If the session key changes continuously, at each change of the session key updated ECMs must be sent to and received by the user.

With a so-called Set-Top-Box which the user obtains from the provider, the EMM and ECM data are decoded inasmuch as the user has acquired the entitlement for this. Such systems have also become known under the notion of Conditional Access (CA). A disadvantage of the system, however, is that each person can decode the data if they secure possession of the Set-Top-Box and of the Smart Card. A personal entitlement verification prior to receiving the data is not provided in a simple embodiment. It is also a disadvantage that the card has to be taken along in order to view the subscribed broadcasts at another location (holidays, business trip, etc.).

German publication DE-A1-102 48 544 therefore discloses a method and a system wherein the security structure of a mobile radio network based on the SIM cards used in mobile radio telephones can be made available to Pay-TV providers and their customers. Although the mobile telephone affords an improved personalization in the described embodiment, the user has no guarantee of data security if other people living at his home have access to the decoder as well as to the subscriber's mobile telephone.

By reason of the mentioned disadvantages, different security mechanisms have become known that use biometric information of the user as additional security. JP2000-341662 uses for example a Set-Top-Box in which the fingerprint of a user has previously been stored. In order to unblock the card, the user must have his fingerprint taken. This is compared locally with the print stored in the Set-Top-Box. If the comparison is positive, the received data are decoded in the manner previously described.

US publication US-A-2003/065957 describes a chip card for a Set-Top-Box in which the fingerprint is also stored locally. During the decoding process, the stored fingerprints are compared with fingerprints taken from the user. Additionally, further information (birthday etc.) is requested. The advantage of such a system is that it is possible to distinguish between different family members.

From WO-A-2003/53060 and WO-A-2004/55717, remote controls are known that can read and use fingerprints.

### REPRESENTATION OF THE INVENTION

The invention has the aim of providing a method and a device for limited-access receiving of data such as for example Pay-TV, which ensures increased security against misuse.

The invention further has the aim of providing a first device in which a person-linked encryption of user data is possible and a second device in which a person-linked decryption of the user data encrypted in the first device is possible.

The aims are achieved according to the invention by a method for limited-access receiving of data, whereas the method has the following method steps:
(a) a first key for encrypting data and a second key for decrypting the data encrypted with the first key are generated on the basis of the user's biometric key data or key data derived therefrom,
(b) in a remote server, data for decoding user data are encrypted with the first key,
(c) the encrypted data for decoding the user data are sent to at least a first terminal of the user,
(d) the encoded user data are sent through a broadcast system to the user and received in a second terminal of the user,
(e) in the second terminal of the user, the received data for decoding the user data are decrypted with the second key,
(f) the user data are decoded with the received and decrypted data for decoding and
(g) subsequently the received user data are available for the user.

The invention is also achieved with a remote server corresponding to claim 18 and a terminal corresponding to claim 21. Advantageous embodiments are indicated in the dependent claims.

In a first advantageous embodiment, the encrypted data for decoding the user data can be sent through the broadcast system as program-accompanying data together with the user data to a common terminal. At the same time, entitlement information (EMM) and control words (ECM) are encrypted as data for decoding the user data. In a second embodiment, the encrypted data for decoding the user data or parts thereof are sent to a mobile telephone or another mobile device as first terminal. The data are then forwarded to a second terminal for decryption.

Advantageously, the user data can be sent together or separately with the program-accompanying data through DAB, DVB, GSM, UMTS, GPRS or the Internet as broadcast system. As key, symmetrical or asymmetrical keys can be used. These keys can be generated on the basis of a fingerprint, of face recognition, iris or retina recognition or recognition of the user's voice, whereas for each user univocal key data are generated on the basis of a specific biometric parameter. For the purpose of retina scanning, a Virtual Retinal Display (VRD) could be used. This has the advantage that recording the user's biometric features can occur continuously and simultaneously with the reproduction of the visual user data. In this case, the method is interactive.

The information can be decrypted as so far in a Set-Top-Box or in a mobile device, preferably in a mobile telephone, as terminal and the received user can be decoded there. Additional security is provided if the second key is generated anew in the terminal each time the user wishes to receive user data.

With the present method, access-limited data can be received at any location, in a hotel, at the office, in a train, on a business trip etc. The hitherto necessary taking along of a card for decrypting the data for decoding the user data can advantageously be omitted. Thanks to the present method, it is advantageously possible to exclude misuse of the system for limited-access receiving of data, since the user has to identify himself biometrically each time prior to receiving data. It is only when the second key generated on the basis of the user's biometric data decrypts the program-accompanying data for decoding the user data that subscribed user data can be reproduced.

### SHORT DESCRIPTION OF THE FIGURES

The invention will be explained in more detail with the aid of the single FIGURE showing a system with which the inventive method can be performed. only the elements essential for understanding the invention are represented.

### WAYS FOR EXECUTING THE INVENTION

The single FIGURE shows a system with which the inventive method for limited-access receiving of audio and/or video data or other user data can be performed. A user with a terminal 1 equipped with a broadcast receiver 1.5 or a user with another broadcast receiver 2-such as e.g. a television or radio apparatus-wishes to receive a limited-access service, a television or radio program etc. in Pay-TV or from the Internet. The user must for this acquire by purchase a corresponding subscription for receiving data from a provider 8 and this is accordingly billed to him by the latter. A physical distribution of encrypted data (software, DVD etc.) as broadcast system 3 is conceivable within the frame of the invention.

In doing so, the user data are broadcast encoded over conventional channels, such as e.g. a satellite transmission, antenna transmission or input into a cable network (DAB; DVB), a telecommunication network GSM, UMTS, over GPRS or over the Internet by a sending equipment 4 attached to a broadcast organization 7. Systems such as DVB-TV, Cable TV, Bluetooth, a system according to IEEE 802.11x, UMS (Unlicensed Mobile Access) are also possible. In addition to these user data, i.e. to the television program or radio broadcast, user-dependent entitlement information (EMM) and control words (ECM) are routinely sent as program-accompanying data.

According to the present invention, this user-dependent entitlement information (EMM) and control words (ECM) are encrypted depending on the user with a first key in a remote server 5. This first key has been generated on the basis of the user's biometric key data or key data derived therefrom. The user data with the encrypted information are sent as program-accompanying data by the remote server 5 over a communication connection 6 to the sending equipment 4 and from there into a broadcast system 3. the encrypted data for decoding the user data can also be sent separately to at least one fist terminal 1 of the user (e.g. to a mobile telephone) and serve for decrypting the user data by the user, as described. The data are then forwarded in an intermediary step to the second terminal 1 (e.g. the Set-Top-Box, video recorder, computer, etc.).

The user receives these data with his terminal 1 or with another broadcast receiver 2. In an additional equipment, such as a Set-Top-Box 2.3, in the terminal 1 or in an identification module of the terminal 1 or of the Set-Top-Box, the EMM and ECM data are decrypted according to the invention with a second key. This second key has also been generated on the basis of the user's biometric key data or key data derived therefrom. Both the terminal 1 as well as the Set-Top-Box 2.3 contain a biometric sensor 10 with which the user's fingerprint is taken. It is obvious that input means of the terminal 1 (remote control, keyboard, mouse etc.) can also be equipped with such a sensor. It is conceivable within the frame of the invention that the terminal 1 connects over a wireless interface (lrDA, Bluetooth, ZigBee etc.) with such a module. A module wire-connected over a USB port with the terminal 1 is also possible within the frame of the invention.

Each time a user wishes to view subscribed data, this second key for decrypting the data is generated anew in the mobile device 1 or in the Set-Top-Box 2.3. This can occur when switching on the device, at the beginning of the program, when switching channels or only after a couple of minutes (the program is shown unencrypted for a couple of minutes). With the received and decrypted data for decoding the user data (entitlement information EMM and control words ECM), the user data are then decoded. After the EMM and ECM data have been decrypted and the user data decoded, the required user data (television program etc.) can be reproduced for the user through a display 1.1, a screen 2.1 or a loudspeaker 2.2.

According to the invention, there are several possibilities for generating the first and second keys. The first and second key can be generated in the user's terminal 1, whereas the first key is sent upon first registration of the user or renewal of the subscription to the remote server 5. A registration in a shop is also possible. It is also conceivable that the user's biometric key data or key data derived therefrom, having recorded by the biometric sensor 10 and then further processed by a program, are sent to the remote server 5. This can also occur in a mobile device of the user that can be independent from the broadcast receiver equipped with the fingerprint sensor. Simultaneously, the broadcast receiver could also be used for this purpose so that only one terminal 1 would be used. The first key is then generated in the remote server 5 whilst the second key is generated locally in the mobile device 1 or in the Set-Top-Box 2.3 on the basis of the user's biometric key data or key data derived therefrom. For each user, univocal key data are previously generated on the basis of a specific biometric parameter. An image of a recorded fingerprint is always slightly different. An algorithm or program is however used to generate from a variable image of a fingerprint a univocal number resp. other univocal key data (algorithmic sequence or matrix). In this manner, a univocal second key can each time be generated to serve to decrypt the data encrypted with the first key. The other used biometric parameters that will be mentioned later also undergo such an algorithm.

As can be seen in the single FIGURE, the mobile terminal 1 is provided with an identification module 1.4, for example a SIM card, and an antenna 1.3 and thus integrated in a network 9. As network 9, it is possible to use for example known mobile radio networks such as GSM, UMTS or also DAB, DVB or other networks known from the prior art. In this manner, a locally generated first key, the biometric data recorded by the sensor 10 or key data derived therefrom can be sent to the remote server 5. This can occur at the same or at another time as when the user sends his subscription duration and the subscription contents he wishes to receive to the remote server 5. The user can enter and send the desired data corresponding to his subscription over the keyboard 1.2 of the mobile terminal 1. The desired user data can also be determined for example by reading a bar code from a television magazine. This is for example also possible by recording the barcode with a camera built in the mobile radio device or with a connected bar code reader. A voice-controlled input the user is lead through after calling a telephone number is also conceivable. It is obvious to the one skilled in the art that the subscription can also occur over a communication network such as the Internet or a fixed network. It is also conceivable that the user has himself registered at a counter or in a shop, e.g. when buying the Set-Top-Box 2.3, indicates his desired contents and has his fingerprints or other biometric information for generating the first key taken.

According to the invention, it is possible to generate a first key as public key and a second key as private key. WO-A-98/48538 discloses for example a method for generating a private key from the biometric data of the user. Such a key could be used to decrypt the EMM and ECM data. In a further embodiment, only a single symmetrical key is generated on the basis of the user's biometric key data or key data derived therefrom. This key serves simultaneously as first and second key within the inventive method. Said EMM and ECM data are thus encrypted in the remote server 5 and decrypted locally at the user's only with this key.

It is obvious that, according to the invention, the first and the second key can be generated on the basis of a plurality of biometric data. It has already been mentioned that they can be generated on the basis of a fingerprint taken from a user. Other biometric data such as face, retina or iris recognition, voice analysis etc. are conceivable within the frame of the invention. For the voice recognition, the mentioned biometric sensor 10 will be a microphone. For the purpose of retina scanning, a Virtual Retinal Display (VRD) could be used. This has the advantage that recording the user's biometric features can occur continuously and simultaneously with the reproduction of the visual user data. In this case, the method is interactive. In a further embodiment, it is only verified whether the biometric parameter can be assigned to a certain group. Since the fingerprints of children are clearly distinguishable from the fingerprints of adults, this could also provide protection against an unauthorized access. A voice analysis can also make the difference between children, women and men and thus allow access to the user data only to an intended target group.

In one embodiment of the present invention, different keys are generated through different fingers (resp. through different fingerprints). It is thus possible to access different subscribed user data or services without having to think long. These services are encrypted with a key, as previously mentioned, that has been generated through a corresponding fingerprint. The different mechanisms for encrypting (symmetrical, asymmetrical key) are equally applicable.

The inventive method also allows group or family management. It is thus possible to subscribe other programs for children than for adults. It can easily be ensured that the children have no access to user data that are not intended for them. Or it is possible for the different members within a flat-sharing community to subscribe a personal program.

The provider 8 of Pay-TV could also operate the remote server 5 and receive and administer the information given by the user. It is also conceivable that the provider 8 of the user data hands over this task to another operator of such a remote server 5. The remote server 5 contains for this purpose a system database 5.1 that contains both personal customer data 5.2 as well as a general broadcast and content management 5.3 for the data subscribed by the customer. The customer data 5.2 also comprise the generated first key that is individual for each customer. The remote server 5 can be operated for different providers 8 of user data that can also be from different countries.

The present invention relates to a remote server 5 that contains a program for decrypting data for decoding user data, whereas the data for decoding the user data are encrypted with a key that has been generated on the basis of the user's biometric data or key data derived therefrom. Advantageously, means could be provided for administering the user data of a plurality of providers, the subscriptions of a plurality of customers and a plurality of individual keys generated on the basis of the user's biometric key data or key data derived therefrom, of different customers.

The invention further relates to a terminal 1 comprising means for generating a key, the key being generated on the basis of the user's biometric key data or key data derived therefrom, and whereas the generated key is used for decrypting the program-accompanying data received through a broadcast system 3 for decoding the user data. As previously explained, the terminal 1 has a biometric sensor 10 and means for generating for each user univocal key data on the basis of a specific biometric parameter.

A described mobile telephone as terminal 1, equipped with a biometric sensor 10 and a broadcast receiver 1.5, allows limited-access data to be received at any location, in a hotel, at the office, in a train, on a trip etc. The hitherto necessary taking along of a card for decrypting the data for decoding the user data can advantageously be omitted. Thanks to the present method, it is advantageously possible to exclude misuse of the system for limited-access receiving of data, since the user has to identify himself biometrically each time prior to receiving data. It is only when the second key generated on the basis of the user's biometric data decrypts the EMM or ECM data that subscribed user data can be reproduced.

### LIST OF REFERENCES

1 Terminal
1.1 Display
1.2 Keyboard
1.3 Antenna
1.4 Identification module
1.5 Broadcast receiver
2 Broadcast receiver
2.1 Screen
2.2 Loudspeaker
2.3 Set-Top-Box
3 Broadcast system
4 Sending equipment
5 Remote server
5.1 System database
5.2 Customer data
5.3 Broadcast and content management
6 Communication connection
7 Broadcast organization
8 Provider
9 Network
10 Biometric sensor

1. Method for a method for limited-access receiving of user data, whereas the method has the following method steps:
(a) a first key for encrypting data and a second key for decrypting the data encrypted with the first key are generated on the basis of the user's biometric key data or key data derived therefrom,
(b) in a remote server, data for decoding user data are encrypted with the first key,
(c) the encrypted data for decoding the user data are sent to at least a first terminal of the user,
(d) the encoded user data are sent through a broadcast system to the user and received in a second terminal of the user,
(e) in the second terminal of the user, the received data for decoding the user data are decrypted with the second key,
(f) the user data are decoded with the received and decrypted data for decoding and
(g) subsequently the received user data are available for the user.

2. The method of claim 2, wherein as data for decoding the user data, entitlement information (EMM) and control words (ECM) are encrypted.

3. The method of claim 1 or 2, wherein the encrypted data for decoding user data are sent through the broadcast system as program-accompanying data with the user data to a common terminal as first and second terminal.

4. The method of claim 1, wherein the encrypted data for decoding user data or parts thereof are sent to a mobile telephone as first terminal and the data are forwarded to the second terminal.

5. The method of claim 1, wherein the user data and/or the data for decoding the user data are sent through DAB, DVB, DVB-TV, Cable-TV, Bluetooth, System according to IEEE 802.11x, UMS, GSM, UMTS, GPRS or the Internet as broadcast system.

6. The method of claim 1, wherein a public key is generated as first key and a private key is generated as second key.

7. The method of claim 1, wherein only a single symmetrical key is generated as first and second key and said information is encrypted and then again decrypted with the single key.

8. The method of claim 1, wherein the first and second key are generated in the user's terminal and the first key is sent to the remote server.

9. The method of claim 1, wherein the user's biometric data or key data derived therefrom are sent to the remote server, a first key is generated in the remote server, and the second key is generated in the terminal on the basis of the user's biometric data or key data derived therefrom.

10. The method of claim 8, wherein the first key, the biometric data or the key data derived therefrom a sent over a telecommunication network, preferably a mobile radio network, to the remote server.

11. The method of claim 8, wherein the user sends, at the same as the encryption data or at another time, his subscription duration and the subscription contents he wishes to receive to the remote server over a telecommunication network, preferably a mobile radio network.

12. The method of claim 1, wherein the first and the second key are generated on the basis of a fingerprint, face recognition, recognition of the iris or retina or recognition of the user's language.

13. The method of claim 1, wherein for recording the biometric data and simultaneously reproducing the user data, a Virtual Retinal Display (VRD) is used.

14. The method of claim 1, wherein for each user, univocal key data are generated on the basis of a specific biometric parameter.

15. The method of claim 1, wherein the data for decoding user data are decrypted in a Set-Top-Box, in a mobile device, preferably a mobile telephone, as terminal or in an identification module of the terminal and the received user data are decoded there.

16. The method of claim 1, wherein the second key is generated anew each time the user wishes to receive and/or decode user data.

17. The method of claim 1, wherein the encrypted information is sent as program-accompanying data with audio and/or video data.

18. The method of claim 1, wherein the user pays a provider of the user data for a corresponding subscription to receive user data.

19. Remote server containing a program for encrypting data for decoding user data, whereas the data for decoding user data are encrypted with a key generated on the basis of the user's biometric or key data derived therefrom.

20. The remote server of claim 19, wherein means are provided for administering the user data of a plurality of providers, the subscriptions of a plurality of customers and a plurality of individual keys generated on the basis of the user's biometric key data or key data derived therefrom, of different customers.

21. Terminal comprising means for generating a key, the key being generated on the basis of the user's biometric key data or key data derived therefrom, and whereas the generated key is used for decrypting the program-accompanying data sent through a broadcast system for decoding the user data.

22. The terminal of claim 21, wherein it has a biometric sensor and means or a program for generating for each user univocal key data on the basis of a specific biometric parameter.

23. The terminal of claim 21, wherein the terminal is a mobile device, preferably a mobile telephone, or a Set-Top-Box.
